(19) United States
(12) Patent Application Publication
(10) Pub. No.: US 2022/0292497 A1
(43) Pub. Date: Sep. 15, 2022

(54) Transaction Based Authentication with Refunded Transactions Removed

(71) Applicant: Capital One Services, LLC, McLean, VA (US)

(72) Inventors: Daniel Miller, Astoria, NY (US); Joshua Edwards, Philadelphia, PA (US); David Septimus, New York, NY (US); Jenny Melendez, Falls Church, VA (US); Tyler Maiman, Melville, NY (US); Viraj Chaudhary, Katy, TX (US); Samuel Rapowitz, Roswell, GA (US); Vyjayanthi Vadrevu, Chicago, IL (US)

(21) Appl. No.: 17/199,708

(22) Filed: Mar. 12, 2021

(51) Int. Cl. G06Q 20/38; H04L 29/06

(52) U.S. Cl. CPC G06Q 20/3821; H04L 63/10

(57) ABSTRACT

Aspects discussed herein may relate to techniques for authenticating a user using transaction-based authentication questions. The transaction-based authentication questions may be generated based on a subset of available financial data. Refund transactions and their related transactions may be identified within the available financial data. Data from the refund transactions and their related transactions may be excluded from being used to generate transaction-based authentication questions. In turn, the transaction-based authentication questions are less likely to confuse the user and are more likely to be memorable to the user. Consequently, the likelihood that the user answers the transaction-based authentication question incorrectly is reduced, thereby avoding delays related to the authentication processes that may frustrate the user.

### FIELD OF USE

Aspects of the disclosure relate generally to authenticating a user. More specifically, aspects of the disclosure provide techniques for excluding data from refund transactions and any related transactions when generating transaction-based authentication questions.

### BACKGROUND

A user may be associated with a financial account maintained by a financial institution. The user may be required to be authenticated in order to grant a request from the user to access sensitive information or to perform a financial transaction associated with the financial account of the user. Conventional systems for authenticating a user may generate transaction-based questions using any data from transactions conducted using the financial account associated with the user. In doing so, the transaction-based questions may involve transactions that are not memorable to the user or might not be typical of most transactions conducted by the user. Such transaction-based questions may confuse the user, leading to the user answering the question incorrectly. For example, if a restaurant incorrectly charged a user for a meal they did not eat, then later refunded the user, the user might not remember the transaction (or may not consider it to be an actual transaction)—but might nonetheless be asked a question about the transaction. As a result, the user may become frustrated with the authentication process and may be required to undergo further authentication processes to be authenticated. This wastes the time and patience of the user and also causes more time and resources to be devoted to authenticating a valid user.

Aspects described herein may address these and other problems, and generally enable a user to be verified in a more reliable and robust manner, thereby improving the experience of the user during the authentication process.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Aspects described herein may provide techniques for identifying refund transactions (e.g., a credited amount transaction) and then excluding data of the refund transactions and any related transactions (e.g., a corresponding charged amount transaction) from being used in the generation of any transaction-based authentication questions. For example, a user may request an action be performed in relation to a financial account of the user. The request may trigger a need to authenticate the user. Transactional data associated with the financial account may be provided. A refund transaction may be identified within the transactional data. The refund transaction may identify an amount credited or refunded to the first financial account. The refund transaction may also identify a merchant. A transaction related to the refund transaction may be identified. The related transaction may identify an amount charged to the first financial account and may also identify the same merchant. Data of the refund transaction and the related transaction (e.g., the merchant name) may be excluded from being used to generate a transaction-based authentication question to authenticate the user. By not using the data of the refund transaction and the related transaction, the user is less likely to be confused by the transaction-based authentication questions, thereby promoting a more efficient authentication process.

For example, some aspects described herein may provide a computer-implemented method for excluding certain data from refund transactions and their related transactions from being used to generate transaction-based authentication questions to authenticate a user. Corresponding apparatus, systems, and computer-readable media are also within the scope of the disclosure.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an example of a computing device that may be used in implementing one or more aspects of the disclosure in accordance with one or more illustrative aspects discussed herein;

FIG. 2 illustrates an operating environment 200 in which transaction-based authentication questions may be generated for authenticating a user;

FIG. 3 illustrates a first example of an authentication question that may be presented to a user;

FIG. 4 illustrates a second example of an authentication question that may be presented to a user;

FIG. 5 illustrates an example method for eliminating false merchant choices from transaction-based authentication questions;

FIG. 6 illustrates an example representation of transactional data that may be stored by a database;

FIG. 7 illustrates an example representation of modified transaction data that may be stored by a database;

FIG. 8 illustrates a third example authentication question that may be presented to a user; and

FIG. 9 illustrates an example method for eliminating refund transactions from generation of transaction-based authentication questions.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

By way of introduction, aspects discussed herein may relate to methods and techniques for authenticating a user. A user may be authenticated using transaction-based authentication questions. The transaction-based authentication questions may be generated in a manner that excludes data from refund transactions and their related transactions, thereby ensuring that the transaction-based authentication questions are directed to transactions that are more memorable and/or less confusing to the user.

Aspects described herein improve the functioning of computers by improving the way in which computing devices authenticate a user. Conventional computing devices implementing conventional techniques for authenticating a user may include data from any transaction in an authentication question. This may lead to the authentication question including information or detail related to transactions that a user might not consider to be a transaction (such as a refund) or detail related to transactions that the user is not likely to remember. As a result, the user may be presented with an authentication question that confuses the user, leading to the user answering an authentication question incorrectly, even though the user is a valid user and should be authenticated. Significant time and energy must then be expended to further attempt to authenticate the user. By providing improved authorization techniques—for example, based on excluding certain data from refund transactions and their related transactions from being used to generate an authentication question that does not confuse the user—authorization may be conducted more accurately and efficiently with lower risk that an actual authorized user is incorrectly and inaccurately denied authentication. Over time, the processes described herein may save processing time, network bandwidth, and other computing resources. Moreover, such improvement cannot be performed by a human being with the level of accuracy obtainable by computer-implemented techniques to ensure accurate authentication of the individual.

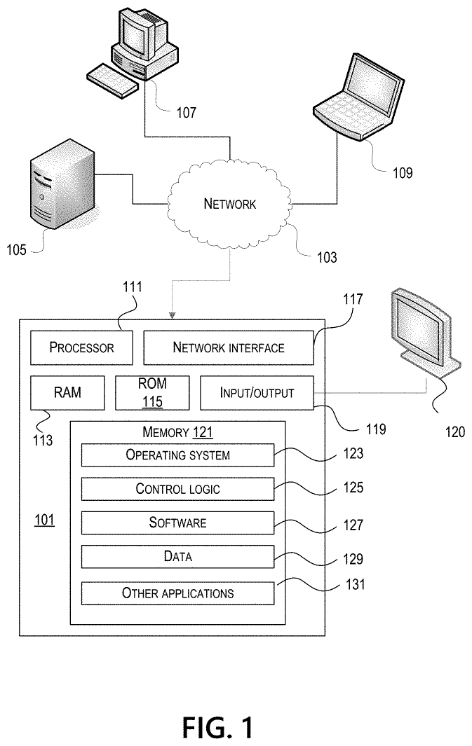

Before discussing these concepts in greater detail, however, several examples of a computing device that may be used in implementing and/or otherwise providing various aspects of the disclosure will first be discussed with respect to FIG. 1.

FIG. 1 illustrates one example of a computing device 101 that may be used to implement one or more illustrative aspects discussed herein. For example, computing device 101 may implement one or more aspects of the disclosure by reading and/or executing instructions and performing one or more actions based on the instructions. The computing device 101 may represent, be incorporated in, and/or include various devices such as a desktop computer, a computer server, a mobile device (e.g., a laptop computer, a tablet computer, a smart phone, any other types of mobile computing devices, and the like), and/or any other type of data processing device.

Computing device 101 may operate in a standalone environment. In others, computing device 101 may operate in a networked environment. As shown in FIG. 1, various network nodes 101, 105, 107, and 109 may be interconnected via a network 103, such as the Internet. Other networks may also or alternatively be used, including private intranets, corporate networks, local area networks (LANs), wireless networks, personal networks (PAN), and the like. Network 103 is for illustration purposes and may be replaced with fewer or additional computer networks. A LAN may have one or more of any known LAN topologies and may use one or more of a variety of different protocols, such as Ethernet. Devices 101, 105, 107, 109 and other devices (not shown) may be connected to one or more of the networks via twisted pair wires, coaxial cable, fiber optics, radio waves, or other communication media.

As seen in FIG. 1, computing device 101 may include a processor 111, RAM 113, ROM 115, network interface 117, input/output interfaces 119 (e.g., keyboard, mouse, display, printer, etc.), and memory 121. Processor 111 may include one or more computer processing units (CPUs), graphical processing units (GPUs), and/or other processing units such as a processor adapted to perform computations associated with machine learning. I/O 119 may include a variety of interface units and drives for reading, writing, displaying, and/or printing data or files. I/O 119 may be coupled with a display such as display 120. Memory 121 may store software for configuring computing device 101 into a special purpose computing device in order to perform one or more of the various functions discussed herein. Memory 121 may store operating system software 123 for controlling overall operation of computing device 101, control logic 125 for instructing computing device 101 to perform aspects discussed herein, software 127, data 129, and other applications 131. Control logic 125 may be incorporated in and may be a part of software 127. In other embodiments, computing device 101 may include two or more of any and/or all of these components (e.g., two or more processors, two or more memories, etc.) and/or other components and/or subsystems not illustrated here.

Devices 105, 107, 109 may have similar or different architecture as described with respect to computing device 101. Those of skill in the art will appreciate that the functionality of computing device 101 (or device 105, 107, 109) as described herein may be spread across multiple data processing devices, for example, to distribute processing load across multiple computers, to segregate transactions based on geographic location, user access level, quality of service (QoS), etc. For example, devices 101, 105, 107, 109, and others may operate in concert to provide parallel computing features in support of the operation of control logic 125 and/or software 127.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a data processing system, or a computer program product.

Having discussed several examples of computing devices which may be used to implement some aspects as discussed further below, discussion will now turn to various examples for generating transaction-based authentication questions.

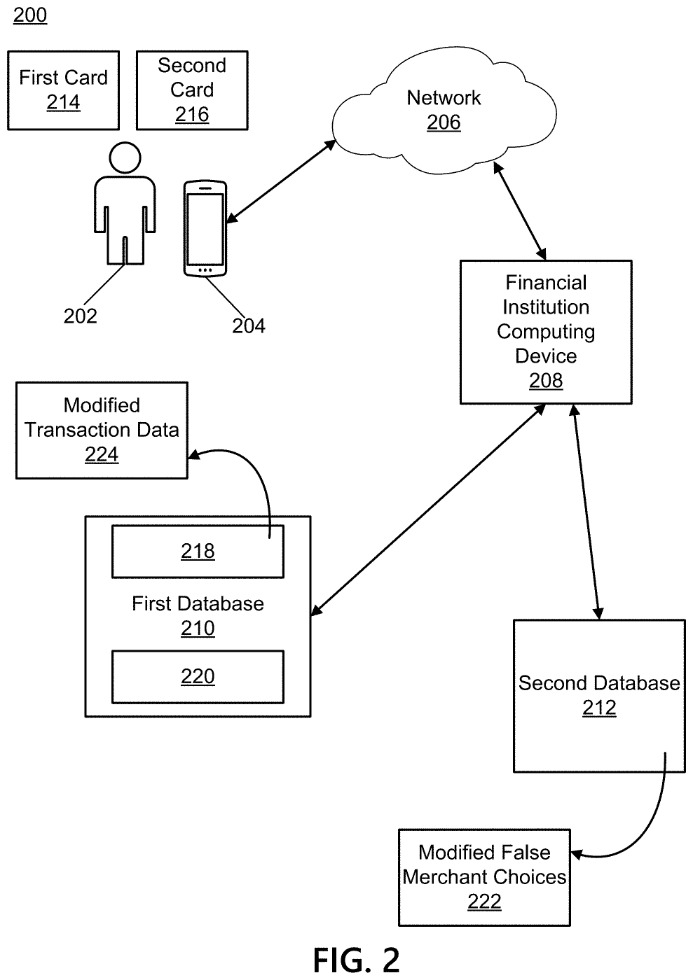

FIG. 2 illustrates an operating environment 200 in which transaction-based authentication questions may be generated for authenticating a user. As shown in FIG. 2, the operating environment may include a user 202, a user computing device 204, a network 206, a financial institution computing device 208, a first database 210, and a second database 212.

The user 202 may be any individual or may represent a legal entity. The user computing device 204 may be any type of computing device including any computing device depicted and described in relation to FIG. 1. The user computing device 204 may be, for example, a smartphone, a laptop, or a tablet. The user computing device 204 may be a wireless device such as, for example, a portable wireless computing device.

The user computing device 204 may be associated with the user 202. The user 202 may use the user computing device 204 to access secure or sensitive information associated with a financial account. The user 202 may use the user computing device 204 to request performance of a transaction associated with a financial account. The user 202 may be or might not be authorized to access sensitive information associated with a financial account. The user 202 may be or might not be authorized to issue a request to conduct a transaction associated with the financial account. For example, the user 202 may be or might not be the true-named-person of the financial account (e.g., the user 202 may or might not be an owner, an authorized user, or an account holder of the financial account subject to a request).

The network 206 may communicatively couple the user computing device 204 with the financial institution computing device 208. The network 206 may be any type of communications and/or computer network. The network 206 may include any type of communication mediums and/or may be based on any type of communication standards or protocols. The network 206 may be the same or similar to the network 103 of FIG. 1. The network 206 enables data or other information to be shared between the user computing device 204 and the financial institution computing device 208.

The financial institution computing device 208 may be any type of computing device including any computing device depicted and described in relation to FIG. 1. The financial institution computing device 208 may be associated with a financial institution. For example, the financial institution computing device 208 might be a server associated with a particular financial institution. The financial institution computing device 208 may represent one or more computing devices and/or a computer network associated with the financial institution. The financial institution computing device 208 may include one or more computers, servers, and/or databases. The financial institution may be a bank, credit union, credit card company, or any other type of financial institution that may provide one or more financial accounts to an individual or legal entity.

The user 202 associated with the user computing device 204 may have one or more financial accounts with the financial institution associated with the financial institution computing device 208. The user 202 may have a checking account, a savings account, a line of credit, and/or a credit card account provided through the financial institution associated with the financial institution computing device 208. In general, the user 202 associated with the user computing device 204 may have any type of financial account with the financial institution associated with the financial institution computing device 208. The user 202 may also have access to a shared account associated with the financial institution computing device 208. The shared account may be a corporate account that multiple individuals may access. The user 202 may also have access to a small-business account associated with the financial institution computing device 208.

As an example, the user 202 may have a first financial account and a second financial account with the financial institution associated with the financial institution computing device 208. The first financial account may be associated with a first card 214. The second financial account may be associated with a second card 216. The first and second cards 214 and 216 may be any type of card such as, for example, a credit card, a payment card, a debit card, a corporate card, or a prepaid card. The user 202 may conduct first transactions (e.g., a first set of transactions) with a first financial account using the first card 214. The user 202 may conduct second transactions (e.g., a second set of transactions) with a second financial account using the second card 216. Accordingly, the user 202 may be associated with the first and second cards 214 and 216.

The financial institution computing device 208 may store information related to various financial accounts associated with the user 202 (e.g., data or other information related to various transactions for each financial account associated with the user 202). For example, the first database 210 may store transactional data associated with one or more accounts the user 202 may have with the financial institution associated with the financial institution computing device 208. The transactional data may include any type of transactional data related to a transaction such as, for example, a date, a time, an amount charged, an amount credited (e.g., an amount refunded), and a merchant name for a transaction. The transactional data may also include stock-keeping unit (SKU) data that may include or may be used to determine an item or service related to a particular transaction (e.g., an item or product purchased during a particular transaction).

As an example, the first database 210 may store first transactional data 218 associated with the first financial account of the user 202, and also associated with the first card 214 associated with the user 202. The first database 210 may also store second transactional data 220 associated with the second financial account of the user 202, and also associated with the second card 216 associated with the user 202. Accordingly, as the user 202 conducts transactions related to the first financial account of the user 202 (e.g., by conducting transaction with a merchant using the first card 214), the first database 210 may collect and store first transactional data 218 associated with the transactions. Additionally, as the user 202 conducts transactions related to the second financial account of the user 202 (e.g., by conducting transaction with a merchant using the second card 216), the first database 210 may collect and store second transactional data 220 associated with the transactions.

The user 202 may use the user computing device 204 to attempt to conduct a financial transaction using (e.g., funded by) the first account maintained by the financial institution computing device 208 and/or the user 202 may use the user computing device 204 to attempt to access sensitive or secure information related to the first account maintained by the financial institution computing device 208. Any such attempt by the user 202 may trigger the financial institution computing device 208 to verify or authenticate the user 202 (e.g., to ensure the user 202 is allowed to access the requested information or to have a requested transaction conducted). For example, any such attempt by the user 202 may cause the financial institution computing device 208 to operate to authenticate the identity of the user 202 to ensure the user 202 is indeed the individual associated with the first financial account and therefore authorized to perform the requested transaction or to access the requested information.

The financial institution computing device 208 may authenticate the user 202 by generating transaction-based questions (e.g., authentication or authorization questions). The authentication questions may be based on transactional data associated with the financial account with which the user 202 requests an action to be performed (e.g., a request to perform a transaction and/or a request to access secure information). The authentication question may be considered to be knowledge-based questions as they require the user 202 to be familiar with underlying data (e.g., transactional data related to a financial account) to answer the questions correctly.

As an example, the user 202 may request an action be performed relating to the first financial account associated with the user 202. In response, the financial institution computing device 208 may receive a request for authorization to perform the action relating to the first financial account associated with the user 202. The financial institution computing device 208 may generate one or more authentication questions based on the first transaction data 218 associated with the first financial account associated with the user 202.

The one or more authentication questions may be directed to any aspect of any transaction conducted using the first financial account associated with the user 202. The financial institution computing device 208 may generate the one or more authentication questions based on the first transactional data 218 stored in the first database 210. As an example, an authentication question may relate to a merchant with which the user 202 has conducted a transaction using the first financial account associated with the user 202 (e.g., by conducting a transaction with the first card 214). The authentication question may ask the user 202 to indicate whether or not the user 202 conducted a transaction with a particular merchant within a particular period of time (e.g., a predetermined period of time prior to the user 202 requesting an action be performed relating to the first financial account associated with the user 202). The authentication question may also include or indicate an amount of a transaction or an item or service that may have been purchased. The authentication question may be posed as any type of question including, for example, a true/false (T/F) question, a multiple-choice question, or a yes/no (Y/N) question. The authentication question may be posed in a manner that requests the user 202 to provide an answer either verbally and/or by entering an answer electronically using the user computing device 204 (e.g., via a keypad or touchscreen). The financial institution computing device 208 may also generate a correct or expected answer to the authentication question.

The authentication question may provide one or more correct answers to the user 202 and/or one or more incorrect or false answers to the user 202. The financial institution computing device 208 may authorize the user 202 (e.g., and/or authorize the request to perform the action relating to the first financial account associated with the user 202) based on the response of the user 202.

For example, the financial institution computing device 208 may generate one or more authentication questions that ask the user 202 whether or not the user conducted a transaction with a particular merchant within the past 30 days and may provide an identifier of a “false merchant.” The false merchant might not be a merchant with which the user 202 conducted a transaction with in the past 30 days using the first financial account of the user 202 (e.g., a “false answer” merchants may be a merchant where the user did not conduct a transaction using the first financial account). If the user 202 responds by indicating the user did not conduct a transaction with the identified “false merchant” in the past 30 days, then the financial institution computing device 208 may determine the user 202 is to be authenticated (the financial institution computing device 208 may determine the user 202 answered correctly). However, if the user 202 responds by indicating the user did conduct a transaction with the identified “false merchant” in the past 30 days, then the financial institution computing device 208 may determine the user 202 is not to be authenticated (the financial institution computing device 208 may determine the user 202 answered incorrectly). Consequently, the request for authorization may be denied, the action request by the user 202 may be denied, and/or the user 202 may be required to perform additional actions to seek authentication that may be onerous or burdensome. Additionally, the financial institution computing device 208 may be required to expend more resources and time validating or authenticating the user 202 that is actually an individual that should be validated but was not authenticated based on an answer to an authentication question).

The second database 212 may store “false merchant” choices (e.g., a stored bank or listing of false merchant identifiers or indicators). The second database 212 may store a relatively large number (e.g., on the order of 50,000) merchant names that may be used by the financial institution computing device 208 to generate one or more “false merchant” choices for an authorization question. The second database 212 may include identifiers for merchants that are similar to the merchants at which the user 202 conducts transactions (e.g., if the user 202 frequently shops at a computer hardware store, then the second database 212 may store identifiers of merchants that sell similar products). In general, the second database 212 may include identifiers for merchants that relate in some manner to merchants that are similar to the merchants at which the user 202 conducts transactions—such as by type of store, location, volume of sales, etc.

To avoid erroneous incorrect answers by the user 202 to any authentication question that involves a false merchant choice, it may be desirous to avoid confusing the user with any presented false merchant choice that includes a merchant with which the user 202 conducted a transaction using an account other than the account that is the subject of an authentication request. For example, it may be desirous to avoid presenting any false merchant choice to a user 202 that an actual authorized user would mistake as a true merchant choice (or with at least a relatively low likelihood of making such mistake). To do so, the financial institution computing device 208 might use false merchant choices that are merchants with which the user 202 has not conducted a transaction within a certain predetermined time period for any account associated with the user 202. In other words, the financial institution computing device 208 might not use false merchant choices that match merchants for which the user 202 did conduct a transaction within the predetermined time period using any other financial account associated with the user 202. By reducing the likelihood of confusing the user 202 with any presented false merchant choice, the likelihood of an actual authorized user answering an authentication question incorrectly is reduced. In turn, incorrect answers from the actual authorized user may be reduced thereby ensuring the actual authorized is authenticated more quickly and efficiently. Further, any authorization delays or denials that the actual authorized user may have to deal with are reduced, resulting in a more satisfied customer.

To reduce confusing the user 202 in such a manner, the financial institution computing device 208 may remove or exclude from an initial set of possible false merchant choices any merchant with which the user 202 conducted a transaction using the second financial account of the user 202 (or any other financial account associated with the user 202). It may then be ensured that the removed or excluded false merchant choices might not be presented to the user 202 as a possible answer to the authentication question (or as the subject of a particular authentication question). Consequently, any confusion to the user 202 that may be caused by such (excluded) false merchant choice may be avoided, and authentication of the user may be conducted more efficiently and expeditiously.

As an example, suppose the user 202 purchased groceries at Jim's Grocery using the first card 214 within the past 20 days. The first database 210 may store transactional data related to this transaction as part of the first transactional data 218 (e.g., the name of the merchant, the date, and the amount charged). Further suppose that the user 202 purchased tires at Luke's Big Box Store using the second card 214 within the past 15 days. The first database 210 may store transactional data related to this transaction as part of the second transactional data 220 (e.g., the name of the merchant, the date, and the amount charged). Additionally, suppose the user 202 did not conduct a transaction at Alan's Big Box Store in the last 30 days with either the first account or the second account. In response to a request for authorization to perform an action related to the first account for the user 202, the financial institution computing device 208 may generate a first authentication question and may present a false merchant choice as an answer. The first authentication may be, for example: “Did you conduct a transaction at Alan's Big Box Store in the past 30 days?” The user 202—assuming the user 202 is the actual account holder or authorized user of the first financial account—is likely to remember that the user did not perform a transaction at Alan's Big Box Store in the last 30 days with the first financial account and is likely to answer correctly by indicating “No.” The user 202 may then be authenticated based on this correct answer to the authentication question. In this manner, authorization may be performed accurately in an efficient manner

As a further example, suppose the first authentication question is presented with a false merchant choice that matches a merchant with which the user 202 conducted a transaction using the second financial account. Under such a scenario, the user 202 may be confused when answering the authentication question. For example, the first authentication question may use Luke's Big Box Store as the false merchant choice, and may ask: “Did you conduct a transaction at Luke's Big Box Store in the past 30 days?” The user 202 might not remember if the user 202 conducted the transaction at Luke's Big Box Store using the first card 214 (the first financial account) or the second card 216 (the second financial account). Because the user might not remember, the user 202 may be confused when answering this authentication question and may incorrectly answer or indicate “Yes.” As a result, the financial institution computing device 208 might not authentication the user or authorize the requested action. The financial institution computing device 208 may institute further steps or processes to authenticate the user 202, thereby requiring the financial institution computing device 208 to expend more time and resources to authenticate the user 202. Additionally, the user 202 may become very frustrated based on the authentication process, due to the confusion caused by the false merchant choice presented to the user 202.

Accordingly, based on one or more techniques described herein, the financial institution computing device 208 may operate to exclude or remove from a set of possible false merchant choices any merchant with which the user 202 conducted a transaction using the second financial account of the user 202. In this manner, a user 202 is less likely to be confused about any correct merchant choices or any false merchant choices presented to the user 202, as any false merchant choice may be ensured to not be a merchant with which the user has conducted a transaction with using the second financial account. Authentication may then be performed in a more expeditious manner with a minimal amount of resources.

Discussion will now turn to various examples for generating transaction-based authentication questions based on the techniques described herein for modifying false answer choices to reduce confusion that the user 202 may experience.

When the user 202 seeks authorization related to an action associated with the first financial account, the financial institution computing device 208 may determine all other financial accounts of the user. For example, the financial institution computing device 208 may determine the user 202 has a second financial account associated with the financial instruction that also maintains the first financial account of the user 202. The financial institution computing device 208 may then access the second transactional data 220 relating to the second financial account associated with the account holder. The financial institution computing device 208 may use the second transactional data 220 to identify one or more merchants with which the user conducted a transaction using the second financial account within a predetermined time period.

The financial institution computing device 208 may then access from the second database 212 a set of stored false merchant choices. The financial institution computing device 208 may then generate a modified set of false merchant choices 222 (as shown in FIG. 2). The modified set of false merchant choices 222 may be a subset of the set of false merchant choices stored by the second database 212. The modified set of false merchant choices 222 may be generated by the financial institution computing device 208 by excluding or removing the one or more merchants with which the user 202 conducted a transaction using the second financial account within the predetermined time period. In this manner, the financial institution computing device 208 may avoid presenting a false merchant choice to the user 202 that matches a merchant that may confuse the user (e.g., a merchant that the user conducted a transaction with using the second card 216). In turn, more accurate answers from the user 202 may be expected and more accurate and efficient authorization processes may be provided to the user 202.

After modifying the set of false merchant choices, the financial institution computing device 208 may generate an authentication question. The authentication question may be any type of question relating to any feature or aspect of a transaction conducted using the first financial account of the user 202. The authentication question may include one or more correct answers and/or one or more incorrect answers. The authentication question may relate to identification or confirmation of a merchant with which the user 202 conducted a transaction. The authentication question may include an identification of one or more merchants with which the user 202 did conduct a transaction using the first account within a predetermined time period and/or the authentication question may include an identification of one or more merchants with which the user 202 did not conduct a transaction using the first account within a predetermined time period (e.g., one or more false merchant choices).

The financial institution computing device 208 may then cause the authentication question to be presented or provided to the user 202. The financial institution computing device 208 may cause an authorization question to be presented to the user 202 in any manner For example, an authorization question may be presented to the user 202 via the user computing device 204. An authorization question may be provided audibly, textually, and/or graphically. For example, an authentication question might be provided as part of a web page, displayed in a web browser executing on the user computing device 204, and as part of an authentication process to allow the user 202 to access other web pages. The user 202 may be prompted to answer the questions. The user 202 may be prompted to provide verbal or audible answers to the questions. The user 202 may be prompted to provide answers by touching or swiping a user interface provided by the user computing device 204. For example, the user 202 may answer audibly or by entering an answer using the user computing device 204 (e.g., via a user interface and/or a display such as a touchscreen display). The financial institution computing device 208 may then use the user's audible answers or physical manipulation of a user interface responses to authenticate or to not authenticate the user 202.

Discussion will now turn to an example authentication question that may be presented to a user that may result in confusing the user—based on conventional techniques—because the authentication question includes false merchant choices associated with another account of the user (e.g., an account different from the account the user is seeking authentication in relation to).

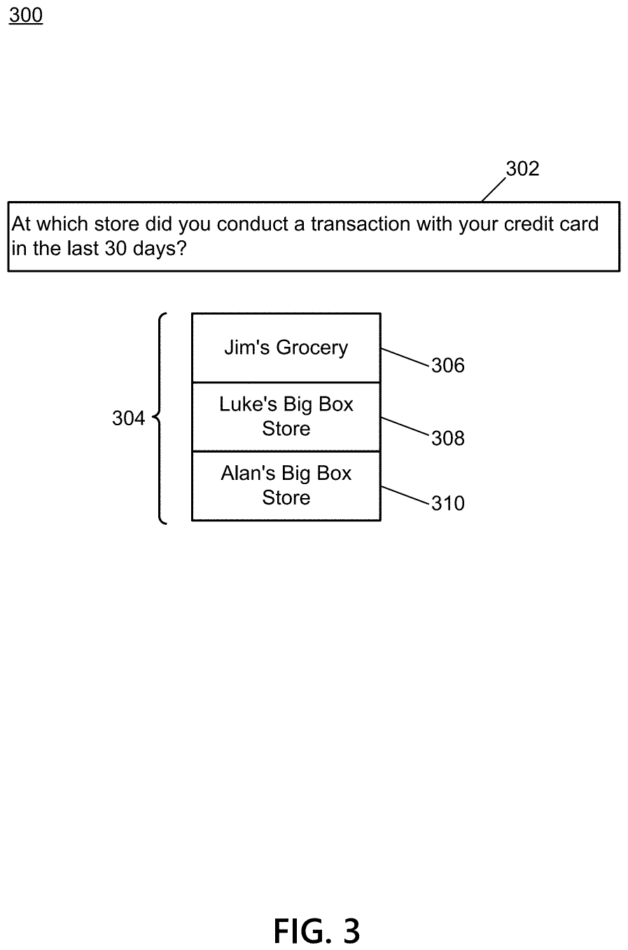

FIG. 3 illustrates an example of a first authentication question 300 that may be presented to a user (e.g., the user 202). The first authentication question 300 may be presented in any manner to the user. The first authentication question 300 may be presented to the user via a display screen (e.g., a display screen of the user computing device 204). The first authentication question 300 may be presented to the user audibly (e.g., via a landline phone or via a speaker of the user computing device 204). The first authentication question 300 may generated by a conventional authentication question generation system and may be caused by the conventional authentication question generation system to be presented to the user.

The first authentication question 300 may include a prompt 302. The first authentication question 300 may further include a set of possible answers 304. Continuing with the authentication question example discussed in relation to FIG. 2, the user may have conducted a transaction at Jim's Grocery with a first card of the user (e.g., the first card 214 of FIG. 2) in the last 30 days. The user might not have conducted a transaction at Luke's Big Box Store with the first card of the user in the last 30 days but may have conducted a transaction at Luke's Big Box Store with a second card of the user (e.g., the second card 216 of FIG. 2) in the last 30 days. The user might not have conducted a transaction at Alan's Big Box Store with the first card or the second card of the user in the last 30 days.

The conventional system may generate a correct or expected answer to the first authentication question 100. For example, based on stored financial data of the user, the conventional system may determine a correct answer to the first authentication question 300. Jim's Grocery may be presented as a first answer choice 306. Luke's Big Box Store may be presented as a second answer choice 308. Alan's Big Box Store may be presented as a third answer choice 310. Jim's Grocery, as the first answer choice 306, may be the correct answer determined by the conventional system. Luke's Big Box Store, as the second answer choice 308, may be presented as a false merchant choice. Alan's Big Box Store, as the third answer choice 310, may also be presented as a false merchant choice.

As noted above, however, the user may have conducted a transaction at Luke's Big Box Store within the past 30 days using the second card 216. As a result, the second answer choice 308 may be a confusing false merchant choice to the user presented with the first authentication question 300. The conventional system may generate the first answer choice 306 as the correct answer choice. Accordingly, if the user responds to the first authentication question 300 by indicating or selecting only the first answer choice 306, then the conventional system may determine that the user answer correctly. In turn, the user may be authenticated.

On the other hand, if the user responds to the first authentication question 300 by not indicating or selecting only the first answer choice 306—for example, by additionally selecting or indicating that the second answer choice 308 is also correct—then then the conventional system may determine that the user answered incorrectly. In turn, the user might not be authenticated. The conventional system may then require the user to perform additional steps or actions to become authenticated which may frustrate the user. As discussed above in relation to FIG. 2, the user may incorrectly also indicate or select the second answer choice 308 because the user may remember conducting a transaction at Luke's Big Box Store but might not remember if the transaction was conducted with the first card 214 or the second card 216.

The user may assume that the conventional system and/or the first authentication question 300 will only ask questions related to transactions conducted with the first card 214. Accordingly, the user may assume that any answer choice that indicates a merchant where the user conducted a transaction using either the first or second card 214 and 216 will be a correct answer. In this manner, the user may be confused by the second answer choice 308 which the conventional system intended to present as a false merchant choice (and therefore not a correct answer).

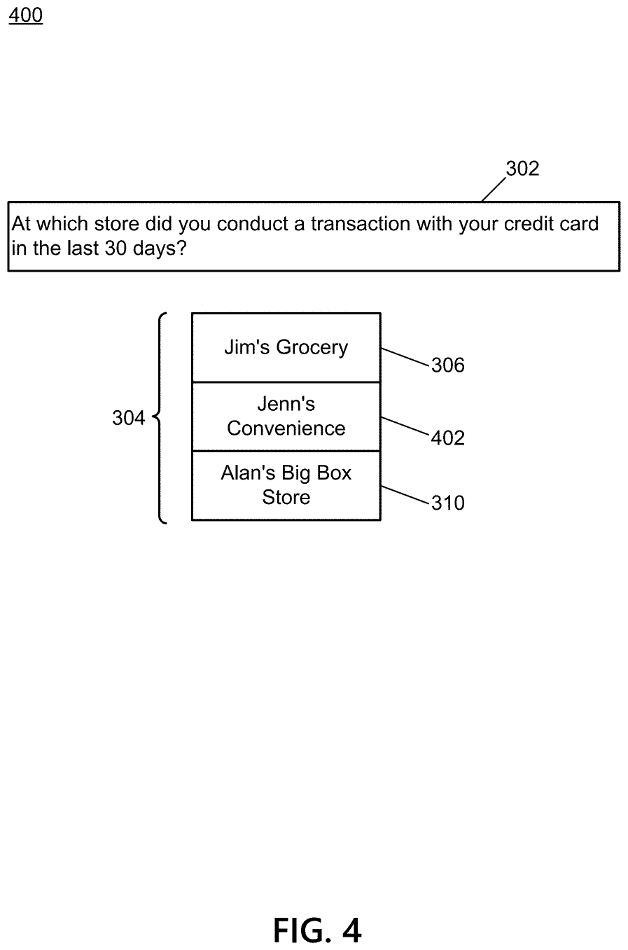

FIG. 4 illustrates an example of a second authentication question 400 that may be presented to a user (e.g., the user 202). The second authentication question 400 may be generated based on the described herein for reducing confusion of the user with respect to presented false answer choices. For purposes of illustration, the second authentication question 400 is illustrated as a modified version of the first authentication question 300 to highlight the manner in which the techniques described herein may reduce a user's confusion in answering the second authentication question 400. The second authentication question 400 may be generated by the financial institution computing device 208 and may be caused by the financial institution computing device 208 to be presented to the user.

In relation to FIG. 4, it may be supposed that the user has not conducted a transaction at Jenn's Convenience in the last 30 days using the first card 214 or the second card 216. Accordingly, Jenn's Convenience may be presented as an additional answer choice 402. In contrast to the conventional system, the techniques described herein—implemented, for example, by the financial institution computing device 208—may exclude the second answer choice 308 as a possible false merchant choice. As a result, the second authentication question 400 may be less confusing to the user than the first authentication question 300, thereby increasing the likelihood that the user answers the second authentication question 400 correctly.

The techniques described herein for generating authentication questions reduces confusion of the user 202 and ensures that the questions, answer, and incorrect answers that may be prevent as a false answer choice (e.g., a false merchant choice), are recognizable and/or memorable to the user 202. As a result, a user 202 may be authenticated in a more reliable and efficient manner Further, the techniques described herein for generating authentication questions reflect the manner in which many users use payment cards and financial accounts different for separate purposes. For example, the user 202 may use the first card 214 for a first type of transaction (purchasing groceries, purchasing gas, etc.) while the user 202 may use the second card 216 for a second type of transaction (purchasing meals at restaurants). Accordingly, the techniques described herein for generating authentication questions allow the user 202 to be authenticated based on an expectations of the user 202 on the type of authentication that will be asked. For example, if the user 202 is seeking to be authenticated for a first financial account associated with the first card 214, the user 202 may expect authentication questions directed to purchases and merchants related to purchasing gas and groceries (not authentication questions directed to purchases of meals at restaurants)—which the techniques described herein may provide. Further, entire accounts may be identified for exclusion. For example, shared accounts or corporate accounts may be excluded from data that may be used to generate authentication questions (e.g., since the user 202 would not expect to be authenticated in relation to a personal account using authentication questions based on data from transactions made with a corporate credit card/account).

Discussion will now turn to an example method for eliminating transactions from related accounts from false answer choices in transaction-based authentication questions.

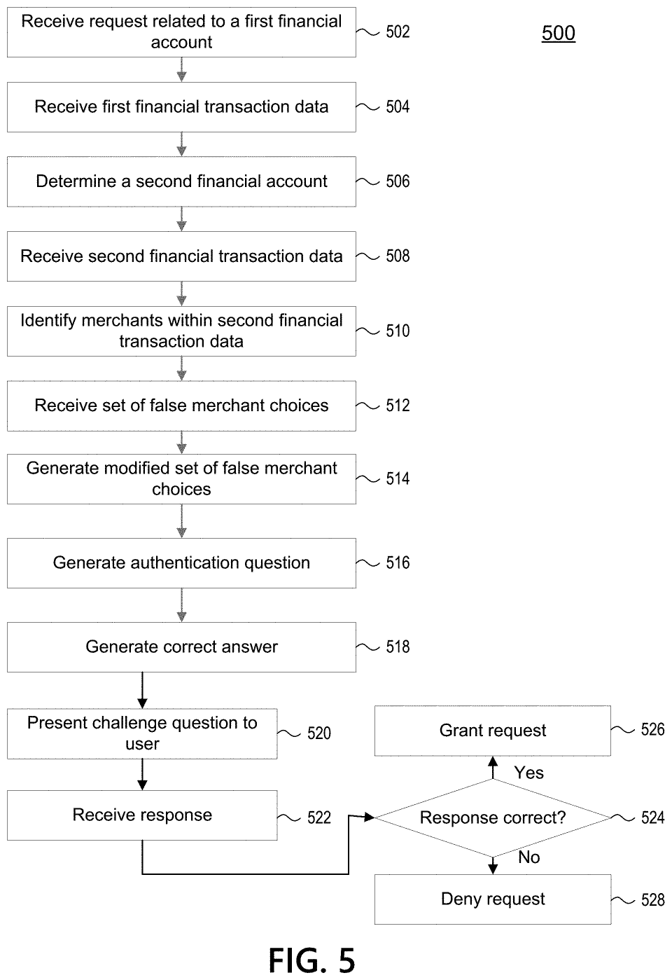

FIG. 5 illustrates an example method 500 for eliminating false merchant choices from transaction-based authentication questions. The eliminated false merchants may be determined based on transitional data associated with another account of user that is different from the account that is subject to authorization using the transaction-based authentication questions. Method 500 may be implemented by a suitable computing system and/or any combination of computing systems or devices, as described herein. For example, method 500 may be implemented in any suitable computing environment by a computing device and/or combination of computing devices, such as computing devices 101, 105, 107, and 109 of FIG. 1 and/or by any one or more of the components depicted in any of FIG. 2 such as, for example, the financial institution computing device 208, the first database 210, and/or the second database 212, or any combination thereof. Method 500 may be implemented in suitable program instructions, such as in software 127, and may operate on data, such as data 129.

At step 502, a request for authorization to perform an action relating to a first financial account associated with a user (e.g., an owner, authorized user, or account holder) may be received. The action may comprise conducting a financial transaction using the first financial account. The action may comprise accessing secure information relating to the first financial account. The action may comprise accessing funds of the first financial account. The first financial account may be any type of account such as, for example, a personal financial account.

At step 504, first financial data relating to the first financial account of the user may be received. The first financial data may be received from one or more databases.

At step 506, a second financial account associated with the user may be determined. The second financial account may be any type of account such as, for example, a corporate or shared financial account. The second financial account may be determined based on information related to the first financial account.

At step 508, second financial data relating to the second financial account associated with the user may be received. The second financial data may be received from the one or more databases.

At step 510, the second financial data may be parsed to identify one or more merchants with which the user conducted a transaction using the second financial account within a predetermined time period. The predetermined time period may be an amount of time such as, for example, a week, a month, or 30 days.

At step 512, a set of false merchant choices may be received. The set of false merchant choices may be received from the one or more databases.

At step 514, a modified set of false merchant choices may be generated. The modified set of false merchant choices may be generated by excluding or removing, from the initial set of false merchant choices, the one or more merchants with which the account holder conducted a transaction using the second financial account within the predetermined time period. The modified set of false merchant choices may therefore be a subset of the initial set of false merchant choices.

At step 516, an authorization question for determining whether to perform the action relating to the first financial account may be generated. The authorization question may be generated based on the first financial data and the modified set of false merchant choices.

At step 518, a correct answer to the authorization question may be generated. The correct answer may be generated based on the first financial data, the authorization question, and the modified set of false merchant choices.

At step 520, the authorization question may be caused to be displayed. The authorization question may include at least one false merchant choice from the modified set of false merchant choices. For example, the authentication question may include the at least one false merchant choice as an option as an answer to the authentication question. The authentication question may include a request to indicate whether the account holder conducted a transaction with the at least one false merchant choice. The authentication question may include: (a) an indicator of an amount of a transaction indicated by the first financial data relating to the first financial account of the account holder; and/or (b) a request to indicate whether the owner conducted the transaction of the indicated amount with the at least one false merchant choice. The authentication question may include the at least one false merchant choice as an option as an answer to the authentication question.

At 522, a response to the authorization question may be received. The response may be received as a verbal response and/or as a response provided though a computing device (e.g., by provided a touch-based input, keyed data entry, or other electronic data entry mechanism).

At 524, the response may be compared to the correct answer. If the response matches the correct answer, then at step 526, the request for authorization may be granted. If the response does not match the correct answer, then at step 528, the request for authorization might not be granted. In this manner, a determination whether to grant the request for authorization to perform the action relating to the first financial account may be based on the response to the authorization question.

Any of the techniques described herein for generating authentication questions may be implemented within a call center environment. For example, the user 202 may use a landline telephone or cellphone to call a call center (or may receive a call from a call center) to effectuate authentication. A call center representative may read an authentication question (including any answer choices) to the user 202 (or an authentication question may be displayed on a device used by the user). The user 202 may answer the authentication questions verbally so that the call center representative may hear the verbal response. The user 202 may then be authenticated or not authenticated based on the verbal response of the user 202.

Discussion will now turn to additional examples for generating transaction-based authentication questions. In particular, discussion will now turn to various examples for generating transaction-based authentication questions that do not involve (or at least limit) details of transactions related to a refund, a return, a credit, or a partial credit.

Returning to FIG. 2, the financial institution computing device 208 may operate to further eliminate certain transactions from being used to generate an authentication question from the same account related to an authentication request, in order to reduce confusion by the user 202. For example, the financial institution computing device 208 may operate to eliminate some or all of the transactional data for certain transactions conducted using the first financial account of the user 202 that is the subject of a request for authorization. The transactions may relate to transactions involving refunds, credit, partial credits, or returns. Such transactions may be considered different by the user 202 from typical transactions that involve a charge amount. The user 202 might not expect an authentication question to include any details related to such transactions and the user 202 may be confused if an authentication question does include any such details, thereby increasing a likelihood that the user 202 answer the authentication incorrectly.

As an example, the user 202 may conduct a first transaction using the first card 214 at Billy's Big Box Store. The first transaction may be a purchase of an item such as a fishing pole. At a later time, the user 202 may return the fishing pole to Billy's Big Box Store and may receive a credit for the return. The return of the fishing pole may be considered to be a second transaction involving the first financial account of the user. The credited amount of the second transaction may match the charged amount from the first transaction. At a further later time, the user 202 may request performance of an action related to the first financial account that requires authentication of the user 202. As part of authenticating the user 202, the financial institution computing device 208 may generate an authentication question based on the stored first transactional data 218. If the authentication question includes some query relating to conducting a transaction or purchasing an item at Billy's Big Box Store, the user 202 may become confused as the user 202 may consider that no transaction occurred since a return was performed. The user 202 may consequently be uncertain as how to answer the authentication question, which may lead to the user 202 answering incorrectly. As discussed above, this may lead to delays in authenticating the user 202 which may frustrate the user. Further, additional processes and additional time is required by the financial institution computing device 208 to authenticate the user 202.

Accordingly, the financial institution computing device 208 may operate to identify, from the stored first transactional data 218, paired transactions that may have been conducted at the same merchant and may involve a refund or credit. The financial institution computing device 208 may then operate to remove all data related to the paired transactions from being used to generate one or more authentication questions. Alternatively, the financial institution computing device 208 may operate to remove much but not all of the data related to the paired transactions from being used to generate an authentication questions as described further below.

Discussion will now turn to examples for recognizing related, refunded, and/or paired transactions by the financial institution computing device 208.

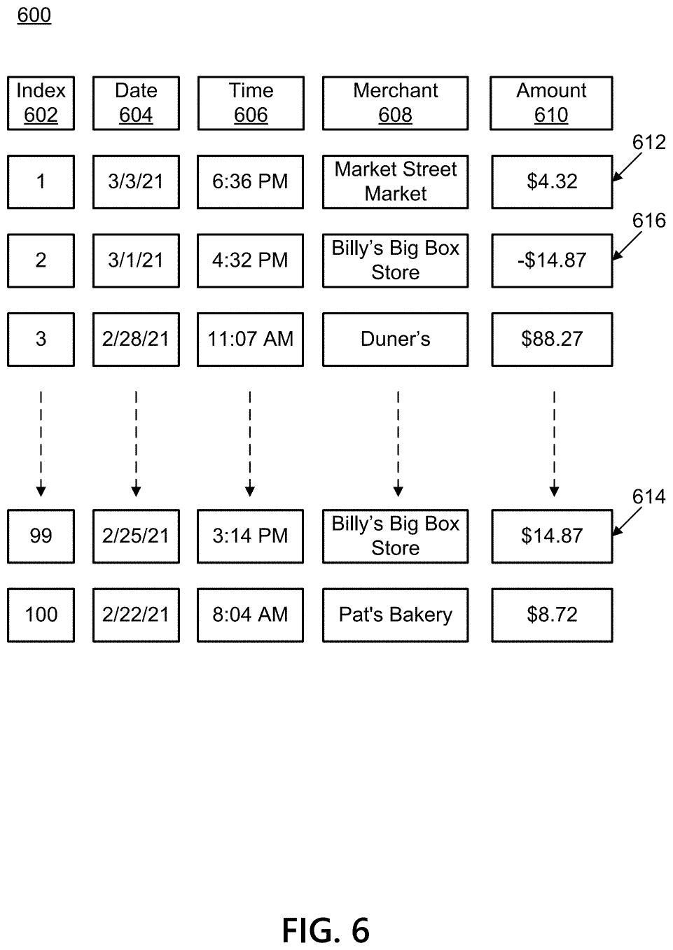

FIG. 6 illustrates an example representation of the transactional data 600 stored by the first database 210. The transactional data 600 may be or may represent the stored first transactional data 218. As shown in FIG. 6, the transactional data 600 may include an index 602. The index 602 may indicate a different transaction. For each transaction, represented by the index 602, data within a date field 604, a time field 606, a merchant field 608, and a transaction amount field 610 may be provided. The transactional data 600 may represent all of the stored first transactional data 218 or may be a subset of the stored first transactional data 218. For example, transactional data 600 may only include data from the stored first transactional data 218 for a certain period of time (e.g., 30 days prior to receipt of a request for authorization associated with the first financial account of the user 202). Although not shown, the transactional data 600 may include SKU level data for each transaction (e.g., such that an item or service may be identified).

As further shown in FIG. 6, the transactional data 600 includes data for 100 transactions. The date field 604 may include or represent the date on which a specific transaction occurred. For example, for a first transaction 612 (e.g., corresponding to an index of “1” in the index field 602), a date of Mar. 3, 2021 is indicated. The time field 604 may include or represent the time of day on which a specific transaction occurred. For example, for the first transaction 612, a time of day of 6:36 PM is indicated. The merchant field 604 may include or represent the merchant where or with which a specific transaction occurred. For example, for the first transaction 612, the merchant Market Street Market is indicated. The merchant field 608 may including any indicator or identifier of a merchant including, for example, a merchant name or a merchant category code. The amount field 604 may include or represent the amount of money involved in a specific transaction occurred. For example, for the first transaction 612, the amount of $4.32 is indicated. The amount field 604 may represent a charge amount (e.g., a debited amount) or a credited amount.

In response to a request for authentication, the financial institution computing device 208 may determine from the transactional data 600 if any transactions involve a first charged amount and a related (e.g., matching) first credited amount. For example, the financial institution computing device 208 may identity that a first paired transaction 614 (e.g., corresponding to an index of “99” in the index field 602) is related to a second paired transaction 616 (e.g., corresponding to an index of “2” in the index field 602). The financial institution computing device 208 may operate to identify refund transactions first (e.g., the second paired transaction 616) and then may operate to identify a corresponding charged amount transaction (e.g., first paired transaction 614). For example, the merchant Billy's Big Box Store may be identified in the merchant field 608 of the second paired transaction 616 and may be used to identify any other transaction that also includes the merchant Billy's Big Box Store in the merchant field 608.

By reviewing the transactional data 600, the financial institution computing device 208 may determine that the first paired transaction 614 involved a purchase at Billy's Big Box Store for an amount of $14.87. The financial institution computing device 208 may further determine that the second paired transaction 616 involved a credit at Billy's Big Box Store for an amount of −$14.87. The financial institution computing device 208 may determine that a negative value within the amount field 610 of a transaction indicates a refund or credited amount. The financial institution computing device 208 may therefore determine that the second paired transaction 616 involved a refund or some credited transaction. The financial institution computing device 208 may then determine that the first and second paired transactions 614 and 616 are related, as each transaction involved the same merchant—Billy's Big Box Store (indicated in the merchant field 608)—and the first and second paired transactions 614 and 616 involved the same amount of money (e.g., as either a credit or a refund and indicated in the amount field 610). The financial institution computing device 208 may also confirm that the first and second paired transactions 614 and 616 are related based on SKU level data provide for each transaction.

After recognizing the relationship between the first and second paired transactions 614 and 616, the financial institution computing device 208 may operate to remove some or all of the transactional data related to the first and second paired transactions 614 and 616 from being used to generate one or more authentication questions. The removed or excluded transactional data related to the first and second paired transactions 614 and 616 may then be prevented from being used to generate an authentication question.

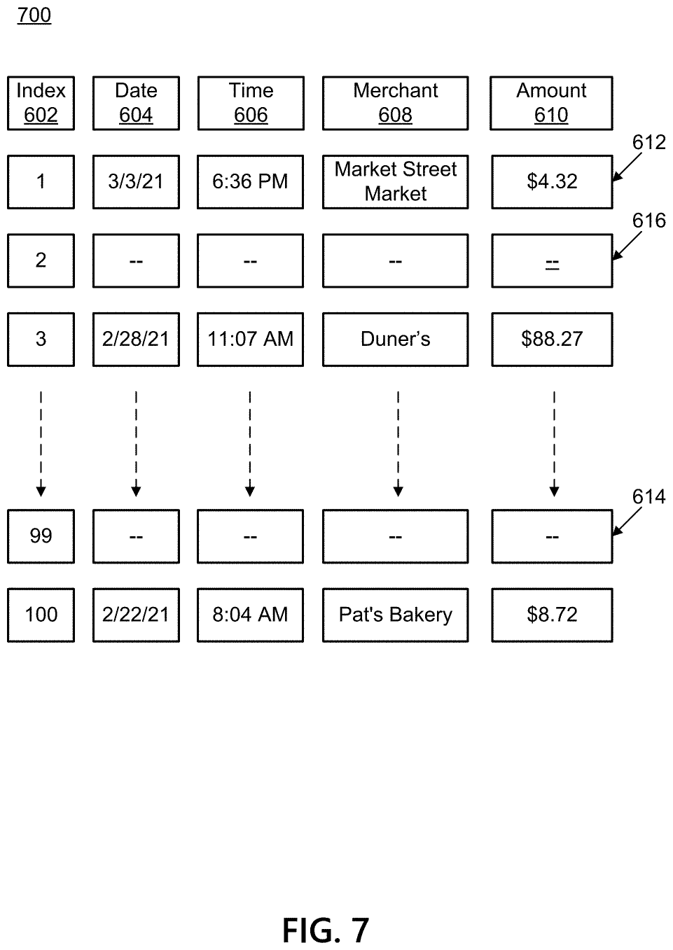

FIG. 7 illustrates modified transaction data 700. As shown, modified transactional data 700 is a modified version of transactional data 600 of FIG. 6. The modified transactional data 700 includes all of the data included in the transactional data 600 except for the data for the first and second paired transactions 614 and 616. The financial institution computing device 208 may user the modified transaction data 700 to generate one or more authentication question for the user 202. Accordingly, possible confusion of the user 202 is eliminated by ensuring the authentication questions do not involve details related to either the first and second paired transactions 614 and 616. In relation to FIG. 2, the modified transaction data 700 may be represented as subset data 224. Subset data 224 may represent a portion of the first transactional data 218. In various embodiments, excluded data may be removed from being used at all—for example, for use in an authentication question, for use as a true merchant answer choice, and/or use as a false merchant answer choice. For example, a list of false merchant choices may be maintained by the financial institution computing device 208. The list of false merchant choices may be a listing of merchant identifiers or names of possible incorrect answer choices (merchants where the user 202 did not conduct a transaction). Further, a list of true merchant choices may be maintained by the financial institution computing device 208. The list of true merchant choices may be a listing of merchant identifiers or names of possible correct answer choices (merchants where the user 202 did not conduct a transaction). In various embodiments, the data associated with the first financial transaction and the second financial transaction may be excluded from the list of false merchant answer choices and from the list of true merchant answer choices. In this manner, confusion of the user 202 may be avoided (or at least the likelihood of possible confusion may be reduced) by removing data (e.g., merchant names from the data of the first financial transaction and the second financial transaction) from any listing or bank of possible answer choices (either false answer choices or correct answer choices).

In various embodiments, all data related to the first and second paired transactions 614 and 616 may be removed or eliminated. In various embodiments, less than all of the data related to the first and second paired transactions 614 and 616 may be removed or eliminated. For example, if the amount charged and corresponding credit amount of the first and second paired transactions 614 and 616 exactly match, all data may be removed. Alternatively, if the amount charged and corresponding credit amount of the first and second paired transactions 614 and 616 exactly match, less than all data may be removed such that certain details of the first and second paired transactions 614 and 616. For example, data related to the merchant or the charge amount or credited amount may be retained and used to generate one or more authentication questions.

Similarly, all or less than all of the data may be removed when the amount charged and corresponding credit amount of the first and second paired transactions 614 and 616 do not exactly match (e.g., based on a partial refund or partial credited amount). This affords the financial institution computing device 208 flexibility in the details that may be presented in an authentication question to the user 202. In this way, distinctive transactions or details thereof may be used to generate an authentication question (e.g., for a particularly memorable transaction involving a relatively large charged amount).

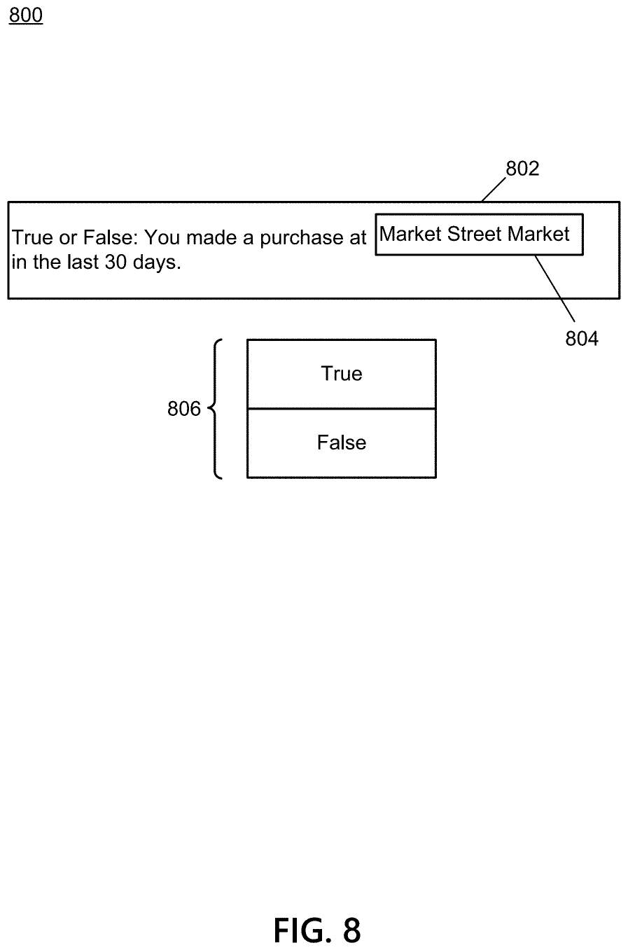

FIG. 8 illustrates an example of an authentication question 800 that may be presented to a user (e.g., the user 202). The authentication question 800 may be presented in any manner to the user. The authentication question 800 may be presented to the user via a display screen (e.g., a display screen of the user computing device 204). The authentication question 800 may be presented to the user audibly (e.g., via a landline phone or via a speaker of the user computing device 204), visibly (e.g., in a web browser executing on the user computing device 204), or the like. The authentication question 800 may be generated by the financial institution computing device 208.

The authentication question 800 may include a prompt 802. The prompt may include a merchant identifier 804. The authentication question 800 may further include a set of possible answers 806 (e.g., a manner for the user 202 to answer True (“T”) or False (“F”) in response to the prompt 802). The authentication question 800 may be generated based on the modified transaction data 700. By generating the authentication question 800 based on the modified transaction data 700, the financial institution computing device 208 may avoid presenting an authentication question that may confuse the user 202 by including data (e.g., a merchant name) related to paired transactions that involved a return or credit (e.g., the first and second paired transactions 614 and 616).

Discussion will now turn to example methods for eliminating refund (or related) transactions for generation of transaction-based authentication questions.

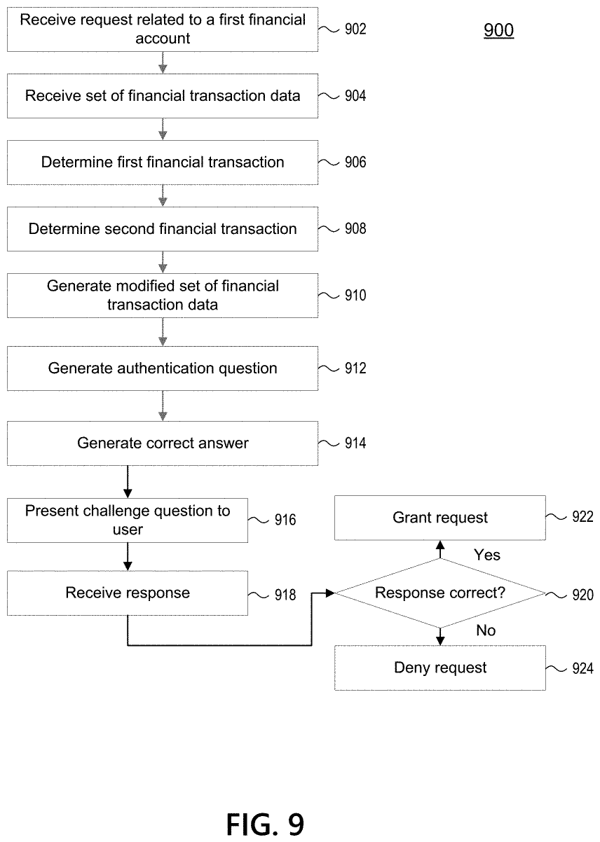

FIG. 9 illustrates an example method 900 for eliminating refund transactions from generation of transaction-based authentication questions. All or some of the data related to refund transactions and any related or paired transactions may be excluded from data used to generate a transaction-based authentication questions. Method 900 may be implemented by a suitable computing system and/or any combination of computing systems or devices, as described herein. For example, method 900 may be implemented in any suitable computing environment by a computing device and/or combination of computing devices, such as computing devices 101, 105, 107, and 109 of FIG. 1 and/or by any one or more of the components depicted in any of FIG. 2 such as, for example, the financial institution computing device 208, the first database 210, and/or the second database 212, or any combination thereof. Method 900 may be implemented in suitable program instructions, such as in software 127, and may operate on data, such as data 129.

At step 902, a request for authorization to perform an action relating to a financial account associated with a user (e.g., an owner, authorized user, or account holder) may be received. The action may comprise conducting a financial transaction using the financial account. The action may comprise accessing secure information relating to the financial account. The action may comprise accessing funds of the financial account. The financial account may be any type of account such as, for example, a personal financial account.

At step 904, a set of financial transaction data relating to the financial account of the account holder for a predetermined period of time may be received. The set of financial transaction data may be received from the one or more databases.

At step 906, a first financial transaction may be determined based on the set of financial transaction data. The first financial transaction may be associated with a first merchant and a first charge amount. For example, the first financial transaction may be associated with Billy's Big Box Store and may involve a charged amount of $14.87.

At step 908, a second financial transaction may be determined based on the set of financial transaction data. The second financial transaction may be associated with the first merchant and a first credit or refund amount. The second financial transaction may be a refund transaction. For example, the second financial transaction may be associated with Billy's Big Box Store and may involve a credited amount of $14.87. In various embodiments, the first charge amount may exactly match the first credited amount. In various embodiments, the first charge amount might not exactly match the first credited amount (e.g., such that the second financial transaction involved a partial refund or credit). In various embodiments, a first indicator of stocking keeping unit (SKU) data associated with the first financial transaction may match a second indicator of SKU data associated with the second financial transaction.

At step 910, a modified set of financial transaction data may be generated. The modified set of financial transaction data may remove or may exclude data (e.g., a portion of data or all data) associated with the first financial transaction and the second financial transaction. Any data related to the first financial transaction and the second financial transaction may be excluded such as, for example, data indicating the first merchant, data indicating the first credited amount, and/or data indicating the first charge amount. In various embodiments, data indicating the first merchant might not be excluded and may be included in the modified set of financial transaction data. In various embodiments, any data related to the first financial transaction and the second financial transaction may be excluded from use in generating an authentication question including, for example, for being used as a false merchant answer choice and/or for being used as a true merchant answer choice.

At step 912, an authorization question for determining whether to perform the action relating to the financial account may be generated based on the modified set of financial transaction data. In various embodiments, the authorization question may include a request to indicate whether a user conducted a transaction with the first merchant. In various embodiments, the authorization question includes a request to indicate whether the user conducted a transaction with a second merchant indicated by data within the modified set of financial transaction data.

At step 914, a correct answer to the authorization question may be generated based on the modified set of financial transaction data and the authorization question.

At step 916, the authorization question may be displayed to a user.

At step 918, a response to the authorization question may be received. The response may be received as a verbal response.

At step 920, the response may be compared to the correct answer. If the response matches the correct answer, then at step 922, the request for authorization may be granted. If the response does not match the correct answer, then at step 924, the request for authorization might not be granted. In this manner, a determination whether to grant the request for authorization to perform the action relating to the first financial account may be based on the response to the authorization question. In various embodiments, if the response does not match the correct answer, an additional authorization question for determining whether to perform the action relating to the financial account may be generated based on the modified set of financial transaction data and presented to the user.

The steps described above in relation to FIG. 9 may be performed in any manner. For example, the method 900 may be performed so that refund transactions are first identified and then matching credit transactions are subsequently identified.

The techniques described herein for removing refund (or related) transactions further ensure that the authentication questions presented to the user 202 are not misleading or confusing to the user. Accordingly, the user 202 may be authenticated more efficiently and with the need for the additional processes or approaches if the user 202 answers an authentication question incorrectly due to confusion of the user 202 caused by the authentication question itself.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method for authenticating a wireless user computing device using authorization questions that reduce user confusion regarding refunded transactions, comprising:
receiving, by a first computing device and from a wireless user computing device, a request for authorization to perform an action relating to a financial account associated with an account holder;
receiving, by the first computing device and from one or more databases, a set of financial transaction data relating to the financial account of the account holder for a predetermined period of time;
identifying, by the first computing device and based on the set of financial transaction data, a first financial transaction, the first financial transaction associated with a first merchant and a first charge amount;
identifying, by the first computing device and based on the set of financial transaction data, a second financial transaction, the second financial transaction associated with the first merchant and a first credit amount;
generating, by the first computing device, a modified set of financial transaction data, the modified set of financial transaction data generated by excluding removing data associated with the first financial transaction and the second financial transaction from the set of financial transaction data;
generating, by the first computing device and based on the modified set of financial transaction data, an authorization question for determining whether to perform the action relating to the financial account;
generating, by the first computing device and based on the modified set of financial transaction data and the authorization question, a correct answer to the authorization question;
causing, by the first computing device, display of the authorization question on a touchscreen of the wireless user computing device;
receiving, by the first computing device and from the wireless user computing device, a response to the authorization question, wherein the response is provided via the touchscreen of the wireless user computing device; and
determining, by the first computing device, whether to grant the request for authorization to perform the action relating to the first financial account based on the response to the authorization question.

2. The method of claim 1, wherein determining whether to grant the request for authorization further comprises comparing the response to the authorization question to the correct answer to the authorization question.

3. The method of claim 2, further comprising granting the request for authorization based on the response to the authorization question matching the correct answer to the authorization question.

4. The method of claim 2, further comprising denying the request for authorization based on the response to the authorization question not matching the correct answer to the authorization question.

5. The method of claim 4, further comprising generating, based on the modified set of financial transaction data, an additional authorization question for determining whether to perform the action relating to the financial account.

6. The method of claim 1, further comprising excluding data indicating the first merchant.

7. The method of claim 1, further comprising excluding data indicating the first charge amount.

8. The method of clam 1, wherein the action comprises accessing funds of the financial account.

9. The method of claim 1, wherein the data associated with the first financial transaction and the second financial transaction is excluded from a list of false merchant answer choices and from a list of true merchant answer choices.

10. The method of claim 1, wherein the first charge amount matches the first credit amount.

11. The method of claim 1, wherein the first charge amount does not match the first credit amount.

12. The method of claim 11, wherein the modified set of financial transaction data includes an identifier of the first merchant.

13. The method of claim 12, wherein the authorization question comprises a request to indicate whether the account holder conducted a transaction with the first merchant.

14. The method of claim 1, wherein a first indicator of stocking keeping unit (SKU) data associated with the first financial transaction matches a second indicator of SKU data associated with the second financial transaction.

15. The method of claim 1, wherein the authorization question comprises a request to indicate whether the account holder conducted a transaction with a second merchant.

16. A computer-implemented method comprising:
receiving, by a first computing device and from a wireless user computing device, a request for authorization to perform an action relating to a financial account;
receiving, by the first computing device and from one or more databases, a set of financial transaction data relating to the financial account;
identifying, by the first computing device and based on the set of financial transaction data, a first financial transaction, the first financial transaction associated with a first merchant and a first charge amount;
identifying, by the first computing device and based on the set of financial transaction data, a second financial transaction, the second financial transaction associated with the first merchant and a first credit amount;
generating, by the first computing device, a modified set of financial transaction data, the modified set of financial transaction data generated by removing:
data indicating the first merchant; and
data indicating the first charge amount, from the set of financial transaction data; and
generating, by the first computing device and based on the modified set of financial transaction data, an authorization question for determining whether to perform the action relating to the financial account;
generating, by the first computing device and based on the modified set of financial transaction data and the authorization question, a correct answer to the authorization question;
causing, by the first computing device, display of the authorization question on a touchscreen of the wireless user computing device;
receiving, by the first computing device, a response to the authorization question wherein the response is provided via the touchscreen of the wireless user computing device; and
granting, by the first computing device, the request for authorization to perform the action relating to the first financial account based on the response to the authorization question matching the correct answer to the authorization question.

17. The method of claim 16, wherein the first charge amount does not match the first credit amount.

18. The method of claim 17, wherein the modified set of financial transaction data includes an identifier of the first merchant.

19. The method of claim 18, wherein the authorization question comprises a request to indicate whether a customer conducted a transaction with the first merchant.

20. One or more non-transitory media storing instructions that, when executed by one or more processors, cause the one or more processors to perform steps comprising:
receive, from a wireless user computing device, a request for authorization to perform an action relating to a financial account associated with an account holder;
receive, from one or more databases, a set of financial transaction data relating to the financial account of the account holder for a predetermined period of time;
identify, based on the set of financial transaction data, a first financial transaction, the first financial transaction associated with a first merchant and a first charge amount;
identify, based on the set of financial transaction data, a second financial transaction, the second financial transaction associated with the first merchant and a first credit amount;
generate a modified set of financial transaction data, the modified set of financial transaction data generated by removing data associated with the first financial transaction and the second financial transaction from the set of financial transaction data;
generate, based on the modified set of financial transaction data, an authorization question for determining whether to perform the action relating to the financial account;
generate, based on the modified set of financial transaction data and the authorization question, a correct answer to the authorization question;
cause display of the authorization question on a touchscreen of the wireless user computing device;
receive a response to the authorization question, wherein the response is provided via the touchscreen of the wireless user computing device; and
determine whether to grant the request for authorization to perform the action relating to the first financial account based on the response to the authorization question.

21. The method of claim 1, further comprising:
receiving, by the first computing device and from the one or more databases, a second set of financial transaction data relating to a second financial account of the account holder;
parsing, by the first computing device, the second set of financial transaction data to identify a second merchant that the account holder conducted a financial transaction with within the predetermined period of time;
receiving, by the first computing device and from one or more second databases, a set of false merchant choices;
generating, by the first computing device, a modified set of false merchant choices, the modified set of false merchant choices generated by removing an identifier of the second merchant from the set of false merchant choices; and
generating, by the first computing device and based on the modified set of false merchant choices, an incorrect answer to the authorization question,
wherein causing display of the authorization question on the touchscreen of the wireless user computing device further comprises causing display of the incorrect answer to the authorization question.
